(19) United States
(12) Patent Application Publication
(10) Pub. No.: US 2014/0212657 A1
(43) Pub. Date: Jul. 31, 2014

(54) ELECTROPHOTOGRAPHIC BELT AND ELECTROPHOTOGRAPHIC APPARATUS

(71) Applicant: CANON KABUSHIKI KAISHA, Tokyo (JP)

(72) Inventor: Taku Kanai, Yokohama-shi (JP)

(73) Assignee: CANON KABUSHIKI KAISHA, Tokyo (JP)

(21) Appl. No.: 14/095,959

(22) Filed: Dec. 3, 2013

(30) Foreign Application Priority Data
Jan. 28, 2013 (JP) 2013-012985

(51) Int. Cl. B32B 5/16; G03G 15/01

(52) U.S. Cl. CPC G03G 15/16
USPC 428/327; 399/302

(57) ABSTRACT

An electrophotographic belt including an electroconductive substrate constituted of a thermoplastic resin or a thermosetting resin, and an electroconductive surface layer. The surface layer includes an energy ray curing resin as a binder resin and fluorine resin particles and electroconductive particles and has a thickness of 1.0 to 4.0 μm. The fluorine resin particles have a primary particle diameter of 0.2 to 0.6 μm and is in a content of 30 to 60 parts by mass relative to 100 parts by mass of the surface layer resin. The electroconductive particles have a primary particle diameter of 1/20 to 1/10 of the primary diameter of the fluorine resin particles. The belt has a volume resistivity ρv (Ω·cm) of 1.0×10⁹≦ρv≦1.0×10¹³. The surface layer has a surface resistivity ρv (Ω/sq.) of 1.0×10⁸≦ρs≦1.0×10¹².

### BACKGROUND OF THE INVENTION

1. Field of the Invention

The present invention relates to an electrophotographic belt for use as an intermediate transfer belt or the like in an electrophotographic apparatus and to an electrophotographic apparatus.

2. Description of the Related Art

An electrophotographic apparatus allows electric charges to be uniformly distributed on an image support, forms an electrostatic latent image on the image support with image signal modulated laser beams or the like, subsequently develops the electrostatic latent image with charged toner for visualization, and transfers the toner image to a transfer material through an intermediate transfer apparatus.

The intermediate transfer apparatus primary-transfers an unfixed toner image on an image support to an electrophotographic belt such as an intermediate transfer belt, and further secondarily transfers the unfixed toner image from the belt to a transfer material such as paper, so that the toner image is transferred onto the transfer material. An intermediate transfer method particularly for a color image forming apparatus allows a multi-transferred synthesis image on an electrophotographic belt to be collectively transferred to a transfer material, having an advantage that a high quality image can be obtained with less influence of the thickness and the surface properties of a transfer material.

Japanese Patent Application Laid-Open No. 2007-316622 discloses an intermediate transfer belt having a highly hardened surface including a substrate and a surface layer of a hardened acrylic resin. According to the disclosure, addition of a resistance adjusting agent to a substrate and a surface layer is preferred, and the surface resistivity is preferably 10⁹ or more and 10¹¹ Ω·cm² or less since an excessively low surface resistivity tends to cause scattering of toner and an excessively high surface resistivity tends to cause unevenness in transfer.

Japanese Patent Application Laid-Open No. 2005-234589 discloses an intermediate transfer material including a surface layer formed of an engineering plastic such as polyphenylene sulfone on a base layer formed of polyurethane elastomer, with a lubricant such as a fluorine resin powder of an ethylene-tetrafluoroethylene copolymer (ETFE) or polytetrafluoroethylene (PTFE) contained in the surface layer.

The present inventor repeated examination of the intermediate transfer belt described in Japanese Patent Application Laid-Open No. 2007-316622.

As a result, when the intermediate transfer belt described in Japanese Patent Application Laid-Open No. 2007-316622 was applied to an electrophotographic apparatus employing a method of removing remaining toner on the surface of an intermediate transfer belt by a cleaning blade disposed in contact with the surface, the cleaning blade was worn away at an early stage due to the large friction force between the surface layer and the cleaning blade, causing cleaning defects in some cases.

On the other hand, it was confirmed that the intermediate transfer material described in Japanese Patent Application Laid-Open No. 2005-234589 had a reduced friction force at the cleaning blade due to the addition of the lubricant to the surface layer.

However, when the lubricant content was increased to, for example, 30 parts by mass or more relative to 100 parts by mass of the resin component of the surface layer for further reduction in the friction force between the surface layer and the cleaning blade, the conductivity of the surface layer was reduced, causing defects in second transfer of the toner image in some cases.

Accordingly, the present invention is directed to providing an electrophotographic belt having excellent surface lubricity and high conductivity.

The present invention is also directed to providing an electrophotographic apparatus capable of forming high quality electrophotographic images in a stable state.

### SUMMARY OF THE INVENTION

According to an aspect of the present invention, there is provided an electrophotographic belt having an electroconductive substrate including a thermoplastic resin or a thermosetting resin, and an electroconductive surface layer; the surface layer including an energy ray curing resin as a binder resin, fluorine resin particles and electroconductive particles; the surface layer having a layer thickness of 1.0 μm or more and 4.0 μm or less; the fluorine resin particles having a primary particle diameter of 0.2 μm or more and 0.6 μm or less; the fluorine resin particles being contained in a content of 30 parts by mass or more and 60 parts by mass or less relative to 100 parts by mass of the binder resin in the surface layer; the electroconductive particles having a primary particle diameter of 1/20 or more and 1/10 or less of the primary diameter of the fluorine resin particles; the belt having a volume resistivity ρv (Ω·cm) of 1.0×10⁹≦ρv≦1.0×10¹⁹; and the surface layer having a surface resistivity ρs (Q/□, termed also as Ω/sq.) of 1.0×10²≦ρs≦1.0×10¹².

According to another aspect of the present invention, there is also provided an electrophotographic apparatus including the above electrophotographic belt as an intermediate transfer belt, and a cleaning blade which is in contact with the surface of the electrophotographic belt.

Further features of the present invention will become apparent from the following description of exemplary embodiments with reference to the attached drawings.

### BRIEF DESCRIPTION OF THE DRAWINGS

FIG. 1 is a schematic cross sectional view of an electrophotographic apparatus having an electrophotographic belt.

FIG. 2 is a schematic cross sectional view of an electrophotographic belt of the present invention.

FIG. 3 is a cross sectional TEM photographic image of an electrophotographic belt of the present invention in the thickness direction.

### DESCRIPTION OF THE EMBODIMENTS

Preferred embodiments of the present invention will now be described in detail in accordance with the accompanying drawings.

As described in Japanese Patent Application Laid-Open No. 2007-316622, the addition of fluorine resin particles to the surface layer of an electrophotographic belt for imparting lubricity, and the addition of electroconductive particles to the surface layer for imparting electroconductivity are independently conventionally known constituent features.

According to the investigation by the present inventor, it was difficult to achieve compatibility between the addition of a large amount of fluorine resin particles to the surface layer and the occurrence of electroconductivity. The reason is due to the difficulty in coexistence of two kinds of particles in the surface layer in different dispersion states.

In order to uniformly impart high lubricity to the surface of the surface layer by incorporating the fluorine resin particles into the surface layer, it is preferred that the particles are uniformly dispersed in the surface layer. On the other hand, in order to impart electroconductivity to the surface layer with electroconductive particles, the electroconductive particles need to be aggregated to a certain extent such that an electroconductive path is formed in the surface layer. It was extremely difficult, however, for the two kinds of particles to coexist in a state that the fluorine resin particles are uniformly dispersed in the surface layer while the electroconductive particles are aggregated.

The present inventor extensively investigated to solve the above technical issue, and found that the use of two kinds of dispersants in preparation for a coating liquid for forming a surface layer allows for the above constituent features, thus having accomplished the present invention.

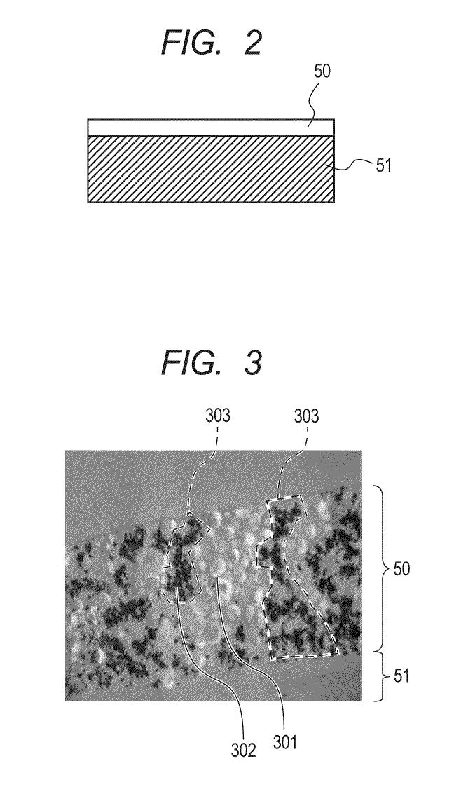

The present invention is described below with reference to the drawings. FIG. 2 is a schematic cross sectional view of an electrophotographic belt of the present invention in the thickness direction, illustrating a base layer 51 and a surface layer 50.

FIG. 3 is a cross sectional image of an electrophotographic belt in Example 1 (described below) as observed in its thickness direction with a 30,000-power transmission electron microscope (TEM). FIG. 3 illustrates a base layer 51 and a surface layer 50, with fluorine resin particles 301 and electroconductive particles 302 in the surface layer 50. The electroconductive particles 302 are aggregated to each other to form a structure for forming an electroconductive path 303 in the surface layer 50. A plurality of electroconductive paths 303 are formed among the fluorine resin particles 301 dispersed in a matrix resin (not shown in drawing) for imparting electroconductivity, such that the surface of the surface layer may have a surface resistivity ρs of 1.0×10⁸Ω/□ (termed as Ω/sq.) or more and 1.0×10¹² Ω/sq. or less.

Surface Layer

An energy ray curing resin composition which is cured by irradiation with energy rays such as electron beams is employed as a binder resin material in the surface layer in order to improve durability (abrasion resistance). Examples of the resin composition include a melamine resin, an alkyd resin, an acrylic resin, and a fluorine-containing resin, including a resin curable upon irradiation with energy rays.

Among them, a resin composition including an acrylic polymer having an unsaturated double bond is preferred from the view point of abrasion resistance. The acrylic polymer having an unsaturated double bond is available, for example, as a UV-ray curable acrylic hard coating material which contains a polyfunctional acryl (trade name: OPSTAR made by JSR).

The surface layer may have a layer thickness of 1.0 μm or more and 4.0 μm or less. The thickness of the surface layer in the range allows the surface layer to have sufficient durability and abrasion resistance and prevents the generation of cracks due to bending of a belt.

Fluorine Resin Particles

In order to suppress the abrasion of the surface layer and reduce the frictional resistance with a cleaning blade, fluorine resin particles are incorporated into the surface layer.

Examples of the fluorine resin particles include the following:

Polytetrafluoroethylene (PTFE) particles, trifluorochloroethylene particles, tetrafluoroethylene hexafluoropropylene particles, vinyl fluoride particles, vinylidene fluoride particles, difluorodichloroethylene particles, and copolymers thereof, and carbon fluoride. Two or more kinds of these may be used in combination.

Among the fluorine resin particles, polytetrafluoroethylene (PTFE) particles are preferred, having the surface of particles with a low friction coefficient so that the friction with other components in contact with the surface layer of an electrophotographic belt can be more effectively reduced.

The fluorine resin particles may have a primary particle diameter of 0.2 μm or more and 0.6 μm or less. The diameter in the range suppresses the aggregation of the fluorine resin particles in a coating liquid for forming a surface layer, so that destabilization of the coating liquid due to precipitation can be prevented.

The amount of the fluorine resin lubricant particles added may be 30 parts by mass or more and 60 parts by mass or less relative to 100 parts by mass of the resin component in the surface layer, from the view point of sufficient reduction in the friction force between the surface of the surface layer and a contact member such as a cleaning blade.

In the case that the content of fluorine resin lubricant particles in the surface layer is less than 30 parts by mass relative to 100 parts by mass of the resin component in the surface layer, sufficient slidability cannot be imparted to the surface of an electrophotographic belt. As a result, when the contact pressure of a cleaning blade is increased, the friction force between the cleaning blade and the electrophotographic belt increases, causing turning-up of the cleaning blade in some cases.

On the other hand, in the case that the content of fluorine resin particles in the surface layer is more than 60 parts by mass relative to 100 parts by mass of the resin component in the surface layer, the effect of binding the fluorine resin particles by a binder resin in the surface layer is weakened. As a result, when the surface of the electrophotographic belt is rubbed with a contact member such as a cleaning blade, the fluorine resin particles may come off in some cases.

In preparation of a coating liquid for forming a surface layer of the present invention, use of a dispersant is required due to the difficulty in dispersion of fluorine resin particles alone in the curable resin composition. A nonaqueous polymer dispersant is preferably used as the dispersant for fluorine resin particles.

Examples of the nonaqueous polymer dispersant include the following:

A partially esterified alkyl polycarboxylate (anionic), a polyether (nonionic), a polyalkylene polyamine (cationic), a high-molecular graft polymer as a compatibilizer resin, and a nonaqueous surfactant dispersant (low-molecular dispersant) such as a polyvalent alcohol ester (nonionic) and an alkyl polyamine (cationic). One kind or two or more kinds of these may be properly selected for use.

Among them, a high-molecular fluorine-containing comb-shaped graft polymer (trade name: GF-300 made by Toagosei Co., Ltd.) is particularly preferred, having both of the performance of an acrylic as a binder and the performance of fluorine of fluorine resin lubricant particles. Due to having both of the performance of an acrylic as a binder and the performance of fluorine of fluorine resin particles, the fluorine resin lubricant particles have excellent dispersibility with a small addition amount.

Although the molecular weight of a fluorine-containing comb-shaped graft polymer is not specifically limited, its number average molecular weight is preferably 100,000 or more and 150,000 or less. The content of a fluorine-containing comb-shaped graft polymer is preferably mass % or more and 5 mass % or less relative to the fluorine resin lubricant particles, more particularly 2 mass % or more and 4 mass % or less.

In the case that the content of a fluorine-containing comb-shaped graft polymer is 1 mass % or more, fluorine resin lubricant particles are well-dispersed in the surface layer resin without aggregation of the fluorine resin lubricant particles. On the other hand, in the case that the content of a fluorine-containing resin comb-shaped graft polymer is 5 mass % or less, the surface layer resin and the fluorine resin lubricant particles are not excessively attached to each other, so that the fluorine resin particles can be exposed to the surface of the surface layer, allowing the surface layer resin not to cover the surface of the fluorine resin particles. As a result, the cleaning performance is sufficiently improved.

Electroconductive Particles

In addition to the surface layer resin and the fluorine rein particles, the incorporation of electroconductive particles allows the surface layer to have a low resistivity. Examples of the electroconductive particles include electroconductive carbon particles in a particle, fiber or flake form, such as carbon black, PAN carbon fibers, and crushed expanded graphite.

Furthermore, the examples also include electroconductive metal particles in a particle, fiber, or flake form, such as silver, nickel, copper, zinc, aluminum, stainless steel, and iron. Alternatively, the examples include electroconductive metal oxide particles in a particle form, such as tin oxide doped with antimony, indium oxide doped with tin, and zinc oxide doped with aluminum, while not limited thereto.

Among them, electroconductive metal oxide particles are preferred, enabling the surface layer to have surface smoothness. Since low resistance can be achieved for the first time with the formation of chain structure of electroconductive particles along the gaps among fluorine resin particles, the electroconductive particles need to have a primary particle diameter of 1/20 or more and 1/10 or less of the primary particle diameter of fluorine resin particles.

In the case that the primary particle diameter of electroconductive particles is larger than 1/10 of the primary particle diameter of fluorine resin particles, no chain structure (electroconductive path) of electroconductive particles is formed along the gap among fluorine resin particles, so that the electric resistance of the surface layer cannot be reduced.

In the case that the primary particle diameter of electroconductive particles is smaller than 1/20 of the primary particle diameter of fluorine resin particles, no electroconductive path is formed due to insufficient proximity among electroconductive particles, so that the electric resistance of the surface layer cannot be reduced.

The amount of electroconductive particles added is preferably 15 parts by mass or more and 30 parts by mass or less relative to 100 parts by mass of the solid content of a UV-ray curable acrylic hard coating material.

In the case that the amount of electroconductive particles added is 15 parts by mass or more, an electroconductive path is formed along the gaps among PTFE particles in the surface layer, so that sufficiently low resistance can be achieved with a volume resistivity of 1.0×10¹³ Ω·cm or less, preventing the force for holding electric charges from increasing excessively. As a result, a static electricity removal mechanism is not required in charging of the surface of electrophotographic belt with a transfer electric field in primary transfer.

The surface resistivity obtained at the same time is 1.0×10¹² Ω/sq. or less, so that no separation discharge occurs at a post-nip part where the image holding member in a primary transfer section and an electrophotographic belt are separated, and no image defect of white spots occurs at a discharged area.

On the other hand, in the case that the amount of electroconductive particles added is 30 parts by mass or less, the volume resistivity is 1.0×10⁹ Ω·cm or more, so that an electrostatic force is properly applied for holding the electric charges of an unfixed toner image transferred from an image holding member to the electrophotographic belt. As a result, toner is not scattered to the periphery of an image due to the electrostatic repulsive force between toner particles and the force of an electric field in the vicinity of the edge of an image, so that an image having a large noise level is hardly formed.

The surface resistivity obtained at the same time is 1.0×10⁸ Ω/sq. or more, so that the electric field intensity is not excessively large at a pre-nip part. As a result, a gap discharge hardly occurs at the pre-nip part, so that the graininess in an image quality is not deteriorated.

Furthermore, in the case that the amount of electroconductive particles added is equal to or less than the predetermined value, the effect of a curable acrylic resin for binding electroconductive particles is not weakened even for a thin surface layer. As a result, the surface layer is not brittle, and is not scraped away by the blade in contact with the surface. No gradual increase in surface roughness thus occurs, causing no problem in the durability.

In preparation of a coating liquid, use of a dispersant is required due to the difficulty in dispersion of electroconductive particles alone, as in the case with the fluorine resin lubricant particles. Examples of the dispersant include a nonaqueous polymer dispersant such as a partially alkyl esterified polycarboxylate (anionic), a polyether (nonionic), and a polyalkylene polyamine (cationic), and a nonaqueous surfactant dispersant (low-molecular dispersant) such as a polyvalent alcohol ester (nonionic) and an alkyl polyamine (cationic). One kind or two or more kinds of these may be properly selected for use, while not limited thereto.

Among them, an alkyl polyamine dispersant is particularly preferred, achieving compatibility between the excellent dispersibility of electroconductive metal oxide particles and the reduction in electric resistance.

The alkyl polyamine dispersant is not a polymer dispersant, allowing particles to be dispersed due to the repulsion of electric charges. As a result, particles can come close to each other to an extent not to cause aggregation without steric effects (repulsion) between electroconductive particles. Among them, a part of the particles adjacent to each other are combined with van der Waals attraction so as to form an electroconductive path, resulting in reduction in electric resistance.

In the case that a high-molecular fluorine-containing comb-shaped graft polymer is used as the fluorine resin lubricant particles, not only no aggregation among the fluorine resin lubricant particles is caused due to the steric repulsion, but also no aggregation is made from the electroconductive particles combined with the fluorine resin lubricant particles due to the steric repulsion of the fluorine resin lubricant particles.

The content of the alkyl polyamine dispersant is preferably 0.1 mass % or more and 2 mass % or less relative to the electroconductive particles, more preferably 0.5 mass % or more and 1 mass % or less.

In the case that the content of the dispersant is 0.1 mass % or more, the presence of electroconductive particles along the gaps among fluorine resin particles in the surface layer allows an electroconductive path to be formed. In the case that the content of the dispersant is 2 mass % or less, the difficulty in exhibiting sufficient electroconductivity in the surface layer due to uniform dispersion of electroconductive particles in the surface layer, not resulting in formation of an electroconductive path, can be avoided.

Substrate

Examples of the thermoplastic resin contained in a substrate include polypropylene (PP), polyethylene (PE), polyamide (PA), polylactic acid (PLA), polyethylene terephthalate (PET), polyethylene naphthalate (PEN), polyphenylene sulfide (PPS), fluorine resin (e.g. PVDF). Examples of the thermosetting resin include polyimide (PI).

The thermoplastic resin or the thermosetting resin in the substrate functions as a matrix resin for other components, which are described in the following. The use of the resin as a main resin of the resin components in a substrate allows the expansion and contraction of the substrate to be suppressed, which is different from the use of elastomer or rubber as a matrix resin of a substrate. As a result, the generation of cracks in a surface layer due to the difficulty for the surface layer to follow the expansion and contraction of the substrate can be effectively prevented.

Examples of the other component contained in a substrate include the following:

An ionic conductive agent (e.g. polymer ionic conductive agent and surfactant), an electroconductive polymer, an antioxidant (e.g. hindered phenol, phosphorus and sulfur), an UV-ray absorbing agent, an organic pigment, an inorganic pigment, a pH adjusting agent, a crosslinking agent, a compatibilizer, a release agent (e.g. silicone and a fluorine resin), a coupling agent, a lubricant, an insulating filler (e.g. zinc oxide, barium sulfate, calcium sulfate, barium titanate, potassium titanate, strontium titanate, titanium oxide, magnesium oxide, magnesium hydroxide, aluminum hydroxide, talc, mica, clay, kaolin, hydrotalcite, silica, alumina, ferrite, calcium carbonate, barium carbonate, nickel carbonate, glass powder, quartz powder, glass fiber, alumina fiber, potassium titanate fiber, and fine particles of a thermosetting resin), electroconductive filler (e.g. carbon black, carbon fiber, electroconductive titanium oxide, electroconductive tin oxide, and electroconductive mica), and ionic liquid.

These may be used singly or two or more kinds may be used in combination.

An electroconductive elastomer such as polyether ester amide may be contained. In the case that an electroconductive elastomer is contained in a substrate, it is preferred that the elastomer is present as a domain in a matrix resin of a thermoplastic resin or a thermosetting resin. As a result, the electroconductivity is imparted to the substrate while the expansion and contraction of the substrate is suppressed.

Electrophotographic Apparatus

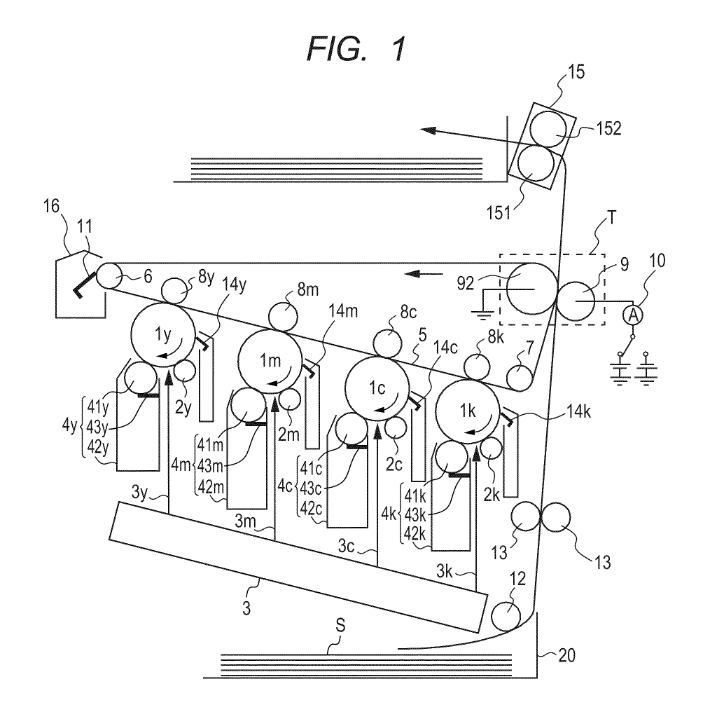

The whole structure of an electrophotographic apparatus of the present invention is described below with reference to FIG. 1.

A color image forming apparatus shown in FIG. 1 includes a plurality of, or four in the present Example, image forming stations Y, M, C and K which are arranged in parallel in an approximately horizontal direction. Each of the image forming stations Y, M, C and K includes a drum-shaped photosensitive member 1 (hereinafter simply referred to as a photosensitive drum), which means that a photosensitive drum 1y for yellow, a photosensitive drum 1m for magenta, a photosensitive drum 1c for cyan, and a photosensitive drum 1k for black are provided.

The photosensitive drum 1 is rotation driven in the arrow direction i.e. in a clockwise direction with a drive unit (not shown in drawing). Around the periphery of the photosensitive drum 1, a charging apparatus 2 (2y, 2m, 2c and 2k) for uniformly charging the surface of the photosensitive drum 1 and a scanner 3 as exposure apparatus for irradiation with laser beams 3y, 3m, 3c and 3k based on image data are sequentially arranged in the rotation direction.

A developing apparatus 4 (4y, 4m, 4c and 4k) which attaches toner to a laser beam irradiation area (light area) of an electrostatic latent image formed on the photosensitive drum 1 by irradiation with the laser beams 3y, 3m, 3c and 3K is also arranged for reversal development to form a toner image.

Each developing unit 4 includes a developing roller 41 (41y, 41m, 41c and 41k) as a developer carrier, a developing blade 43 (43y, 43m, 43c and 43k), and a developer container 42 (42y, 42m, 42c and 42k).

The developer container 42 (42y, 42m, 42c and 42k) supplies toner to the developing roller 41. The developing blade 43 (43y, 43m, 43c and 43k) restricts the amount of toner on the developing roller 41 so as to impart electric charges to toner.

Furthermore, around the photosensitive drum 1, an electrophotographic belt 5 is arranged as an intermediate transfer belt which is in contact with the photosensitive drum 1 and rotates in the counterclockwise direction. A primary transfer roller 8 (8y, 8m, 8c and 8k) is also arranged opposite to the photosensitive drum 1, as a primary transfer unit for transferring a toner image on the photosensitive drum 1 to the electrophotographic belt 5.

A photosensitive drum cleaning blade 14 (14y, 14m, 14c and 14k) is arranged downstream the opposite part of the primary transfer roller 8, as a cleaning member for removing remaining toner on the photosensitive drum 1.

The toner image on the electrophotographic belt 5 is transferred to a transfer material S by a secondary transfer roller 9 as a transfer unit (secondary transfer unit).

As described above, in the present Example, an electrophotographic apparatus includes four developing units 4, each having a developing roller 41, a developing blade 43, and a developing container 42. In the present Example, a developing unit 4y for yellow, a developing unit 4m for magenta, a developing unit 4c for cyan, and a developing unit 4k for black are provided.

The structure of respective components are sequentially described below.

The photosensitive drum 1 includes an aluminum cylinder having a diameter of, for example, 30 mm, of which the outer peripheral surface is coated with an organic electroconductive layer (OPC photosensitive member). The photosensitive drum 1 is rotatably supported with a support member (not shown in drawing) at both ends so as to be rotation driven in a clockwise direction in the drawing by the drive force transmitted from a drive motor (not shown in drawing) to one of the ends.

The charging apparatus 2 in the present Example is a contact-type charging apparatus including electroconductive rollers 2y, 2m, 2c and 2k in a roller shape. The charging apparatus 2 allows the rollers to come in contact with the surface of the photosensitive drum 1 and applies a predetermined charging bias with negative polarity at a level equal to or higher than the discharge initiation voltage to the rollers with a power source (not shown in drawing), so that the surface of the photosensitive drum 1 is uniformly charged with negative polarity. The surface potential of the uniformly charged photosensitive drum 1 is hereinafter referred to as dark area potential.

The scanner 3 is a laser optical unit which allows a drive circuit (not shown in drawing) to control the lighting of laser beams 3y, 3m, 3c and 3k in response to image signals, so that the electrically charged surface of the photosensitive drum 1 is selectively exposed to form an electrostatic latent image. The surface potential of the photosensitive drum 1 having an electrostatic latent image formed thereon is hereinafter referred to as a light area potential.

The four developer units 4 include developing containers 42 which contain yellow, magenta, cyan and black toners, respectively, in this order from the upstream side (left side in FIG. 1) in the rotation direction of the electrophotographic belt 5, and the developing rollers 41.

Toner is transported from the developing container 42 to the developing roller 41, and the toner attached to the developing roller 41 is charged with a uniform polarity (negative polarity in this instance), due to scraping with the developing blade 43. The developing roller 41 comes in contact with the photosensitive drum 1 and a developing bias with negative polarity at a level lower than the dark area potential and higher than the light area potential as an absolute value is applied to the developing roller 41, so that toner can be attached to an area of the electrostatic latent image corresponding to the light area potential only, in the transitioned state. Subsequently, image exposure is performed by laser beams so as to visualize the image as a toner image.

The primary transfer roller 8 represents electroconductive rollers 8y, 8m, 8c and 8k in a roller form. Examples of the roller include a shaft of metal such as SUS having an outer diameter of 6 mm and an elastic foam roller having an outer diameter of 12 mm around the periphery of the shaft, having a resistance of 10⁶Ω or more and 10⁹Ω or less. The primary transfer roller 8 is pressed against the photosensitive drum 1 through the electrophotographic belt 5 and a primary transfer bias with positive polarity is applied to the roller from a power source (not shown in drawing), so that the toner image on the photosensitive drum 1 can be transferred onto the electrophotographic belt 5.

The electrophotographic belt 5 is stretched with a secondary transfer facing roller 92 for rotating the electrophotographic belt 5, a tension roller 6 for applying a proper tension, and a drive roller 7, and rotated in the arrow direction.

The secondary transfer facing roller 92 for use has an outer diameter of 25 mm, including an aluminum cored bar coated with ethylene-propylene-diene rubber (EPDM rubber) having an electrical resistance of 1.0×10⁴Ω, and a thickness of 1.5 mm, in which carbon is dispersed as an electroconducting agent.

The tension roller 6 as a stretching member includes a metal bar of aluminum having an outer diameter of 25 mm, having a tension of 19.6 N on one side, and 39.2 N as a total pressure.

The drive roller 7 for use as a stretching member has an outer diameter of 25 mm, including an aluminum cored bar coated with EPDM rubber having an electrical resistance of 10⁴Ω, and a thickness of 1.0 mm, in which carbon is dispersed as an electroconducting agent.

The secondary transfer roller 9 has the same structure and physical properties as the primary transfer roller 8. The secondary transfer roller 9 is pressed against the electrophotographic belt 5 through a transfer material S and a secondary transfer bias with positive polarity is applied to the roller from a power source (not shown in drawing), so that the toner image on the electrophotographic belt 5 is transferred onto the transfer material S.

In order to form an image with the electrophotographic apparatus, the transfer materials S housed in a cassette 20 mounted in the lower part of the apparatus body are separately fed one by one with a feeding roller 12. The transfer material S is then fed to a secondary transfer part T with a pair of transporting rollers 13, so that the toner images of yellow, magenta, cyan and black formed on the electrophotographic belt 5 are secondarily transferred to the transfer material S to form a color image.

The transfer material S is passed through a fixation apparatus 15 including a roller pair of a heating roller 151 and a pressure roller 152, and then ejected to the upper part of the apparatus. After transfer of a toner image from the electrophotographic belt 5 to a transfer material, the remaining toner on the electrophotographic belt 5 after the secondary transfer is removed with a cleaning blade (cleaning member) 11 so as to be collected in a toner collection container 16.

The cleaning blade 11 as a member for collecting remaining toner on the electrophotographic belt 5 includes a sheet metal part (not shown in drawing) of plated sheet steel and a rubber part (not shown in drawing) of polyurethane rubber bonded to the metal part. The rubber part has a thickness of 2.0 mm. The tip of the rubber part is coated with a mixed liquid of SEFBON (SEFBON-CMA HFE-700 made by Central Glass Co., Ltd.) and hydrofluoroether (HFE-700 made by Sumitomo 3M Limited) for improvement in slidability with the electrophotographic belt 5.

The cleaning blade 11 has an oscillating structure in which a rocking shaft (not shown in drawing) is fixed to an electrophotographic belt unit and a pressure spring (not shown in drawing) applies pressure to a sheet plate, so that the cleaning blade 11 is moved around the rocking shaft. At the attachment position of the cleaning blade 11, the setting angle θ (an angle formed between a roller tangent and a cleaning blade rubber part at the intersection of the electrophotographic belt and the cleaning blade) is 14.4° or larger and 30.3° or smaller, and the contact pressure of the cleaning blade 11 is 45 N/m or more.

According to the present invention, in an electrophotographic apparatus having a cleaning member in contact with the surface of a belt, an electrophotographic belt and an electrophotographic apparatus having an improved image while satisfying cleaning performance are provided through the use of a substrate including a binder resin except for rubber and thermoplastic elastomer and a surface layer arranged on the substrate having desired abrasion resistance, low friction resistance, and electrical resistance.

### EXAMPLES

The following Examples and Comparative Examples are provided to specifically describe the present invention. In Examples and Comparative Examples, electrophotographic belts were made. The physical properties observed in the Examples and Comparative Examples were measured as follows.

(Measurement Method and Evaluation Method for Physical Properties)

The measurement method and evaluation method for electrophotographic properties of the electrophotographic belt made in Examples and Comparative Examples are as follows.

(1) Evaluation of Resistance

The volume resistivity ρv of an electrophotographic belt and the surface resistivity ρs on the surface layer side thereof were measured by the following method.

An electrophotographic belt obtained by the manufacturing method was left standing in an environment with a temperature of 23° C. and a relative humidity of 50% for 6 hours in advance, and then measured. A high-resistance meter (trade name: HIGHRESTA UP (MCP-HT450) made by Mitsubishi Chemical Corporation) was used as a measurement apparatus. A ring-shaped probe (trade name: UR-100 (diameter of central electrode: 5.0 cm; inner diameter of outside electrode: 5.32 cm) made by Mitsubishi Chemical Corporation) was used as a surface electrode.

In the measurement of volume resistivity, a measurement sample was placed on the metal surface side of REGI-TABLE UFL (made by Mitsubishi Chemical Corporation) and a voltage of 500 V was applied between the central electrode of the ring-shaped probe and the metal surface of the REGI-TABLE UFL. The measurement value was obtained after 10 seconds.

In the measurement of surface resistivity on the surface layer side, a measurement sample was placed on the TEFLON (registered trade name) surface side of REGI-TABLE UFL (made by Mitsubishi Chemical Corporation) and a voltage of 500 V was applied between the central electrode of the ring-shaped probe and the outside electrode. The measurement value was obtained after 10 seconds.

For an arbitrarily sampled electrophotographic belt, 8 points (2 points in width direction by 4 points in circumferential direction) were measured and averaged.

(2) Evaluation of Primary Particle Diameter

The primary particle diameter of the fluorine resin particles and the electroconductive particles contained in the electrophotographic belt was evaluated by the following method.

Arbitrary 4 spots were selected from a manufactured electrophotographic belt. The part of the respective cross sections were further cut out by freezing superthin section method for observing and photographing the sample in the thickness direction of the belt by a 60,000-power transmission electron microscope (TEM).

At least 100 unaggregated fluorine resin particles were arbitrarily selected from the obtained photograph. The maximum lengths (nm) of the respective particles were measured and the arithmetic mean value thereof was defined as the primary particle diameter of the fluorine resin particles in the present invention.

At least 100 unaggregated electroconductive particles also were arbitrarily selected from the obtained photograph. The maximum lengths of the respective particles were measured and the arithmetic mean value thereof was defined as the primary particle diameter of the electroconductive particles in the present invention.

(3) Evaluation of Transfer Efficiency

An electrophotographic belt was mounted on the electrophotographic apparatus shown in FIG. 1. For an image pattern as a solid patch printing image with a 300% density, at a secondary transfer bias for minimizing the amount of toner remained after a secondary transfer, the transfer efficiency (%) was calculated from the toner weights before and after the secondary transfer. The closer to 100% transfer efficiency, the less amount of toner is remained after transfer, which means excellence in transfer performance. The experimental results were graded into two groups.

TABLE 1

| | |
|---|---|
| A | Transfer efficiency of 96% or more, for both initial use and after |
| | feeding of 50,000 sheets of paper |
| B | Transfer efficiency less than 96%, for initial use or after feeding |
| | of 50,000 sheets of paper |

With a transfer efficiency less than 96%, a small number of image defect such as granular texture of toner and white spots can be visually confirmed.

(4) Evaluation of Cleaning Performance

An electrophotographic belt was mounted on an electrophotographic apparatus shown in FIG. 1. The electrophotographic apparatus includes a cleaning blade 11 made of urethane rubber.

A full solid image with a 200% density was formed on the electrophotographic belt 5 and the whole amount of toner used in the full solid image was collected with the cleaning blade. Subsequently 15 sheets of a solid white image were outputted. The obtained solid white image is referred to as “initial solid white image” in this specification. The “initial solid white image” was visually observed for whether remaining toner uncollected with the cleaning blade was attached or not.

Subsequently 50,000 sheets of A4 size paper printed with an image of 4-point size alphabet “E” characters with a coverage rate of 1% (hereinafter also referred to as “character E image”) were outputted. A full solid image with a 200% density was then formed on the intermediate transfer belt 5 and the whole amount of toner used in the full solid image was collected with the cleaning blade. Subsequently 15 sheets of a solid white image were outputted. The obtained solid white image is referred to as “solid white image after endurance” in this specification. The “solid white image after endurance” was visually observed for whether remaining toner uncollected with the cleaning blade was attached or not. Furthermore, the cleaning blade was taken out from the electrophotographic apparatus after forming the solid white image after endurance, so as to be observed for the abrasion state of the part in contact with the electrophotographic belt with an optical microscope with a magnifying power of 100. The evaluation results are described according to the standard in the following Table 2.

TABLE 2

| | |
|---|---|
| A | Absence of toner attached to any of one of initial solid white image |
| | and solid white image after endurance due to defects in cleaning |
| | toner on electrophotographic belt. Abrasion amount of cleaning |
| | blade part in contact with electrophotographic belt after forming |
| | solid white image after endurance of less than 1 μm. |
| B | Absence of toner attached to any of one of initial solid white image |
| | and solid white image after endurance due to defects in cleaning |
| | toner on electrophotographic belt. Abrasion amount of cleaning |
| | blade part in contact with electrophotographic belt after forming |
| | solid white image after endurance of 1 μm or more. |
| C | Presence of toner attached to both initial solid white image and solid |
| | white image after endurance due to defects in cleaning toner |
| | on electrophotographic belt. |

### Example 1

### Material of Substrate

The material compounding ratio for thermoplastic resin composition of a substrate for use in the following Examples and Comparative Examples is shown in Table 3.

TABLE 3

| | | Compounding |
|---|---|---|
| | | ratio (parts by |
| | Material name and properties | mass) |
| PE | Polyethylene terephthalate | 82 |
| | (trade name: TR-8550 made by Teijin | |
| | Chemicals Ltd.) | |
| | Tm 260° C. | |
| | Intrinsic viscosity: 0.50 dl/g | |
| | (at 25° C., 0.5 mass % o-chlorophenol | |
| | solution) | |
| PEEA | Polyether ester amide | 16 |
| | (trade name: IRGASTAT P20 made by Ciba | |
| | Specialty Chemicals Co., Ltd.) | |
| | Tm 180° C. | |
| Additive 1 | Surfactant | 2 |
| | Potassium perfluoro butane sulfonate | |
| | (trade name: KFBS made by Mitsubishi | |
| | Materials Corporation) | |
| Additive 2 | Carbon black | 1 |
| | (trade name: MA-100 made by Mitsubishi | |
| | Materials Corporation) | |

Using a twin screw extruder (trade name: TEX30α made by Japan Steel Works, Ltd.), a thermoplastic resin composition was prepared by thermal fusion kneading according to the compounding ratio described in Table 3. The thermal fusion kneading temperature was adjusted in the range of 260° C. or higher and 280° C. or lower, and the thermal fusion kneading time was about 3 to 5 minutes. The obtained thermoplastic resin composition was pelletized and dried at a temperature of 140° C. for 6 hours. Subsequently the dried thermoplastic resin composition in a pellet form was fed into an injection molding apparatus (trade name: SE180D made by Sumitomo Heavy Industries, Ltd.), so as to be injection molded in a mold at an adjusted temperature of 30° C. with a cylinder at a setting temperature of 295° C. for forming of a preform. The obtained preform had a test-tube shape with an outer diameter of 20 mm, an inner diameter of 18 mm, and a length of 150 mm.

Subsequently, the preform is arranged in a heating apparatus having a noncontact heater for heating the outer wall and inner wall of the preform. The preform was heated with the heater such that the outer surface temperature of the preform reached 120° C. Subsequently, the preform was biaxially stretched with a biaxial stretch blow molding apparatus. More specifically, the heated preform was arranged in a blow mold at a fixed mold temperature of 30° C. and stretched in the axial direction with a stretching rod. Air at an adjusted temperature of 23° C. was fed into the preform from a blow air injection part at the same time, so that the preform was stretched in the diameter direction. A biaxially stretched bottle-shaped molding was thus obtained.

(Material for Surface Layer)

The compounding ratio for the material of surface layer in Example 1 is described in Table 4.

TABLE 4

| | | Compounding |
|---|---|---|
| | | ratio (parts by |
| | | mass as solid |
| | Material name and properties | content) |
| UV-ray curable | OPSTAR (acrylic UV-curable material) (made by | 100 |
| hard coating | JSR) | |
| material | Solid content: 50 wt % | |
| Fluorine lubricant | LUBRON L-2 (PTFE particles) (made by Daikin | 30 |
| particles | Industries, Ltd.) | |
| | Primary particle diameter: 0.3 μm | |
| Electroconductive | CELNAX (isopropyl alcohol sol of zinc antimonate) | 15 |
| particles | (made by Nissan Chemical Industries, Ltd.) | |
| | Primary particle diameter: 20 nm | |
| | Solid content: 20 wt % | |
| Dispersant for | GF-300 (high-molecular fluorine-containing comb- | 3.9 wt % relative |
| PTFE particles | shaped graft polymer) | to PTFE particles |
| | (made by Toagosei Co., Ltd.) | |
| Dispersant for | AMIET 102 (polyoxyethylene alkyl amine) | 0.75 wt % relative |
| electroconductive | (made by Kao Corporation) | to |
| particles | | electroconductive |
| | | particles |

Dispersion treatment of a coarsely dispersed liquid of materials, except for the electroconductive particles and a dispersant for electroconductive particles, with a compounding ratio described in Table 4, was performed with a high-pressure emulsion dispersion machine (trade name: NANOVATER made by Yoshida Kikai Co., Ltd). The final dispersion treatment was performed until the average particle diameter of 50% of the contained PTFE particles reached 200 nm.

Furthermore, while a liquid to which the electroconductive particles and the electroconductive particle dispersant were added was agitated, the liquid including the final dispersed PTFE particles was added dropwise so that a coating liquid for forming a surface layer was obtained.

The particle diameter of particles in the coating liquid was measured by a dynamic light scattering (DLS) method (standard ISO-DIS 22412, 2006) with a particle analyzer for concentrated solution, FPAR-1000 made by Otsuka Electronics Co., Ltd.

Subsequently, a substrate for the electro-photographic belt was dip-coated with the UV-ray curable resin composition in a coating environment at 25.0° C. with a relative humidity of 60%.

After completion of coating, the surface layer was cured by irradiation with UV-rays, using a UV-ray irradiation apparatus (trade name: UE06/81-3 made by Eye Graphics Co., Ltd., accumulated light intensity: 1,000 mJ/cm²) in the same environment as that of coating. As a result, a cured resin film having a thickness of 2.0 μm was formed as the surface layer of an electrophotographic belt.

The cross section of the electrophotographic belt manufactured by the above method was made by freezing superthin section method for observing the cross section of the surface layer by a transmission electron microscope (acceleration voltage: 100 KV), so that the primary particle diameters of the fluorine resin particles and the electroconductivity imparting particles were calculated.

In the present Example, the obtained volume resistivity ρv was 1.0×10¹⁰ Ω·cm and the surface resistivity ρs was 3.0×10⁹ Ω/sq., which were within standard, having caused no image defect such as white spots and deteriorated granularity, having achieved excellent image properties with a transfer efficiency of 98%.

Since the resistance was within standard, no static electricity removal mechanism was required.

According to the evaluation results of cleaning in the present Example, no cleaning defect occurred in both of the initial use of the blade and the use after feeding of 50,000 sheets of paper. The abrasion amount of the contact part of the blade was 5 μm after feeding of 50,000 sheets of paper.

### Example 2

In the present Example, the material formulation of thermoplastic resin composition for a substrate and the manufacturing method for a substrate were the same as in Example 1.

In the formulation of UV-ray curable resin composition for a surface layer in Example 1, the compounding ratio of fluorine lubricant particles was changed to 50 parts by mass, and the compounding ratio of electroconductive particles was changed to 25 parts by mass. Except for these changes, an electrophotographic belt was manufactured in the same way as in Example 1. The surface layer of the electrophotographic belt obtained in the present Example had a thickness of 2.5 μm, a volume resistivity ρv of 8.5×10¹¹ Ω·cm and a surface resistivity ρs of 1.2×10¹⁰ Ω/sq. As a result of observation of the cross-sectional TEM image in the thickness direction, the presence of an electroconductive path formed of aggregate of zinc antimonate particles was confirmed as shown in FIG. 3.

In the present Example, the volume resistivity ρv and the surface resistivity ρs were within standard, having achieved an excellent transfer efficiency of 98% or more, in the same way as in the Example 1. Furthermore, due to the increase in the amount of PTFE powder as fluorine resin particles, the surface of the surface layer had a low friction coefficient, so that the abrasion amount of a cleaning blade in contact with the electrophotographic belt was reduced. As a result, the abrasion amount of the contact part of the blade was 1 μm or less, so that the cleaning performance was substantially improved compared to Example 1.

### Comparative Example 1

In the present Comparative Example, the material formulation of thermoplastic resin composition for a substrate and the manufacturing method for a substrate were the same as in Example 1.

In the formulation of UV-ray curable resin composition for a surface layer in Example 1, the compounding ratio of fluorine lubricant particles was changed to 20 parts by mass, and the compounding ratio of electroconductive particles was changed to 10 parts by mass. Except for these changes, a transfer belt was manufactured in the same way as in Example 1.

The surface layer of the electrophotographic belt obtained in the present Comparative Example had a thickness of 2.0 μm, a volume resistivity ρv of 6.0×10⁹ Ω·cm and a surface resistivity ρs of 1.0×10⁹ Ω/sq.

In the present Comparative Example, the volume resistivity ρv and the surface resistivity ρs were within standard, having achieved an excellent transfer efficiency of 98% or more, as in Example 1. Due to the reduction in the amount of PTFE powder as fluorine resin particles, the surface of the surface layer had a high friction coefficient, so that the abrasion amount of the contact part of a blade reached 20 μm after feeding of 50,000 sheets of paper, having caused cleaning defects.

### Comparative Example 2

In the present Comparative Example, the material formulation of thermoplastic resin composition for a substrate and the manufacturing method for a substrate were the same as in Example 1.

In the formulation of UV-ray curable resin composition for the surface layer in Example 1, the compounding ratio of fluorine lubricant particles was changed to 70 parts by mass.

And the compounding ratio of electroconductive particles was changed to 35 parts by mass. Except for these changes, a transfer belt was manufactured in the same way as in Example 1. The surface layer of the electrophotographic belt obtained in the present Comparative Example had a thickness of 3.0 μm, a volume resistivity ρv of 4.0×10¹² Ω·cm and a surface resistivity ps of 3.0×10¹¹ Ω/sq.

In the present Comparative Example, the volume resistivity ρv and the surface resistivity ρs were within standard, having achieved an excellent initial transfer efficiency of 98% or more, as in Example 1. Due to the excessive addition of PTFE powder as fluorine resin particles, however, the effect of the hard coating material for binding PTFE particles was weakened, so that the contact with a blade caused detachment of PTFE particles. Consequently the slidability was gradually deteriorated. The abrasion amount of the contact part of a blade reached 100 μm after feeding of 50,000 sheets of paper, having caused cleaning defects.

Due to the detachment of PTFE particles, the surface smoothness of the surface layer of the transfer belt was deteriorated, so that the transfer efficiency after feeding of 50,000 sheets of paper was reduced to 90%. As a result, image defects such as granular texture of toner and white spots were visually confirmed.

### Comparative Example 3

In the present Comparative Example, the material formulation of thermoplastic resin composition for a substrate and the manufacturing method for a substrate were the same as in Example 1.

In the formulation of UV-ray curable resin composition for a surface layer in Example 1, the compounding ratio of fluorine lubricant particles was changed to 50 parts by mass, and the compounding ratio of electroconductive particles was changed to 10 parts by mass. Except for these changes, a transfer belt was manufactured in the same way as in Example 1.

The surface layer of the electrophotographic belt obtained in the present Comparative Example had a thickness of 2.0 μm, a volume resistivity ρv of 5.5×10¹³ Ω·cm and a surface resistivity ρs of 2.0×10¹² Ω/sq.

In the present Comparative Example, since the volume resistivity ρv and the surface resistivity ρs were high, separation discharge easily occurred at a post-nip part where the image holding material of a primary transfer part and an electrophotographic belt are separated, having caused an image defect of white spots at a discharged portion. Furthermore, due to the large force for holding electric charges, the surface of the electrophotographic belt was charged by the transfer electric field in primary transfer, so that the transfer efficiency was substantially reduced to 80% after feeding of 50,000 sheets of paper.

The contact part of a blade had, however, an abrasion amount of 1 μm or less after feeding of 50,000 sheets of paper, having achieved excellent cleaning performance.

### Comparative Example 4

In the present Comparative Example, the material formulation of thermoplastic resin composition for a substrate and the manufacturing method for a substrate were the same as in Example 1.

In the formulation of UV-ray curable resin composition for a surface layer in Example 1, the compounding ratio of fluorine lubricant particles was changed to 50 parts by mass, and the compounding ratio of electroconductive particles was changed to 40 parts by mass. Except for these changes, a transfer belt was manufactured in the same way as in Example 1. The surface layer of the electrophotographic belt obtained in the present Comparative Example had a thickness of 2.0 μm, a volume resistivity ρv of 2.4×10⁸ Ω·cm and a surface resistivity ρs of 3.2×10⁷ Ω/sq.

In the present Comparative Example, due to the low volume resistivity ρv and the low surface resistivity ρs, the effect of electrostatic force for holding the electric charges of an unfixed toner image transferred from an image holding material to the electrophotographic belt is weakened. Consequently, due to the electrostatic repulsion force between toner particles and the force of electric field in the vicinity of the edge of an image, toner is scattered to the periphery of the image, so that an image having a large noise level is formed. At the same time, due to the increased electric field intensity at a pre-nip part, a gap discharge easily occurred at a pre-nip part, so that the graininess in an image quality was deteriorated. As a result, the transfer efficiency was reduced to 86% after feeding of 50,000 sheets of paper. The contact part of a blade, however, had an abrasion amount of 1 μm or less after feeding of 50,000 sheets of paper, so that an excellent cleaning performance was achieved.

### Comparative Example 5

In the present Comparative Example, the material formulation of thermoplastic resin composition for a substrate and the manufacturing method for a substrate were the same as in Example 1. The formulation and the manufacturing method of the UV-ray curable resin composition for a surface layer also were the same as in Example 1. The surface layer had a thickness of 5.0 pt. The electrophotographic belt obtained in the present Comparative Example had a volume resistivity ρv of 1.5×10¹² Ω·cm and a surface resistivity ρs of 4.5×10¹⁰ Ω/sq.

In the present Comparative Example, the volume resistivity ρv and the surface resistivity ρs were within standard, having achieved an excellent transfer efficiency of 98% or more, in the same way as in the Example 2. Due to the large thickness of the surface layer, however, when 1,000 sheets of paper were fed, the surface layer failed to follow the bending drive of the electrophotographic belt. As a result, the surface layer was cracked and a cleaning defect occurred from the crack.

### Comparative Example 6

In the present Comparative Example, the material formulation of thermoplastic resin composition for a substrate and the manufacturing method for a substrate were the same as in Example 1. In the formulation of UV-ray curable resin composition for a surface layer in Example 1, the dispersant for electroconductive particles was changed from polyoxyethylene alkyl amine (trade name: AMIET 102 made by Kao Corporation) to the following amphiphilic copolymer with the following addition amount. Except for the change, a transfer belt was manufactured in the same way as in Example 1.
An amphiphilic copolymer having a functional group having high affinity with electroconductive particles and a structure including a salvation moiety, which is classified as a polymer type dispersant for nonaqueous system (trade name: DISPERBYK 2155 made by BYK-Chemie Japan K.K.)
Addition amount: 1.5 mass % relative to electroconductive particles.

The electrophotographic belt obtained in the present Comparative Example had a volume resistivity ρv of 9.8×10¹³ Ω·cm and a surface resistivity ρs of 2.2×10¹³ Ω/sq.

The polymer type dispersant used caused steric effects (repulsion) between electroconductive particles. As a result, although particles were not aggregated, particles were prevented from coming close to each other, so that an electroconductive path of bonded particles was not formed due to the absence of van der Waals attraction between particles. Consequently the surface layer had a high electric resistance. As a result, separation discharge frequently occurred at a post-nip part where the image holding material of a primary transfer part and the electrophotographic belt are separated, so that the evaluation of transfer efficiency was unavailable due to many image defects of white spots. The evaluation of cleaning performance was also unavailable due to insufficient toner transfer.

The evaluation results in Examples and

Comparative Examples are described in the following Table 5.

TABLE 5

| | | | Comparative | Comparative | Comparative | Comparative | Comparative | Comparative |
|---|---|---|---|---|---|---|---|---|
| | Example 1 | Example 2 | Example 1 | Example 2 | Example 3 | Example 4 | Example 5 | Example 6 |
| ρv | 1.0 × 10¹⁰ | 8.5 × 10¹¹ | 6.0 × 10⁹ | 4.0 × 10¹² | 5.5 × 10¹³ | 2.4 × 10⁸ | 1.5 × 10¹² | 9.8 × 10¹³ |
| (Ω · cm) | | | | | | | | |
| ρs | 3.0 × 10⁹ | 1.2 × 10¹⁰ | 1.0 × 10⁹ | 3.0 × 10¹¹ | 2.0 × 10¹² | 3.2 × 10⁷ | 4.5 × 10¹⁰ | 2.2 × 10¹³ |
| Ω/sq. | | | | | | | | |
| Image evaluation | A | A | A | B | B | B | A | — |
| (Transfer efficiency | | | | | | | | |
| evaluation rank) | | | | | | | | |
| Cleaning | B | A | C | C | A | A | C | — |
| performance | | | | | | | | |
| evaluation rank | | | | | | | | |

As shown in Table 5, having a volume resistivity pv and a surface resistivity ρs in the predetermined ranges allowed for ensured transfer efficiency and stable blade cleaning, having achieved the required performance for an electrophotographic belt.

The present invention is not limited to the specific embodiments and various modifications may be made based on the gist of the present invention, which are not excluded from the scope of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-012985, filed Jan. 28, 2013, which is hereby incorporated by reference herein in its entirety.

What is claimed is:

1. An electrophotographic belt comprising:
an electroconductive substrate comprising a thermoplastic resin or a thermosetting resin, and
an electroconductive surface layer, wherein:
the surface layer comprises an energy ray curing resin as a binder resin, fluorine resin particles and electroconductive particles;
the surface layer has a thickness of 1.0 μm or more and 4.0 μm or less;
the fluorine resin particles has a primary particle diameter of 0.2 μm or more and 0.6 μm or less;
the fluorine resin particles are contained in a content of 30 parts by mass or more and 60 parts by mass or less relative to 100 parts by mass of the binder resin in the surface layer;
the electroconductive particles has a primary particle diameter of 1/20 or more and 1/10 or less of the primary diameter of the fluorine resin particles;
the belt has a volume resistivity ρv (Ω·cm) of 1.0×10⁹≦ρv≦1.0×10¹³; and
the surface layer has a surface resistivity ρs (Ω/sq.) of 1.0×10⁸≦ρs≦1.0×10¹².

2. The electrophotographic belt according to claim 1, wherein the substrate comprises a thermoplastic resin or a thermosetting resin as a matrix resin and an electroconductive elastomer as a domain.

3. The electrophotographic belt according to claim 1, wherein the fluorine resin particles are polytetrafluoroethylene (PTFE) particles.

4. The electrophotographic belt according to claim 1, wherein the electroconductive particles are metal oxide particles.

5. The electrophotographic belt according to claim 1, wherein the electroconductive particles form an electroconductive path in the substrate.

6. An electrophotographic apparatus comprising
the electrophotographic belt according to claim 1 as an intermediate transfer belt, and
a cleaning blade which is in contact with the surface of the surface layer of the electrophotographic belt.
